(19) United States
(12) Patent Application Publication
(10) Pub. No.: US 2011/0178705 A1
(43) Pub. Date: Jul. 21, 2011

(54) Using Filtering With Mobile Device Positioning In A Constrained Environment

(75) Inventors: Payam Pakzad, Mountain View, CA (US); Alok Aggarwal, Foster City, CA (US); Rajarshi Gupta, Santa Clara, CA (US)

(73) Assignee: QUALCOMM INCORPORATED, SAN DIEGO, CA (US)

(21) Appl. No.: 12/987,898

(22) Filed: Jan. 10, 2011

Related U.S. Application Data
(60) Provisional application No. 61/295,575, filed on Jan. 15, 2010.

(51) Int. Cl. G01C 21/00

(52) U.S. Cl. 701/209; 701/208

(57) ABSTRACT

The subject matter disclosed herein relates to systems, methods, apparatuses, devices, articles, and means for using filtering with mobile device positioning in a constrained environment. For certain example implementations, a method may comprise obtaining at least one position measurement of a mobile device and filtering the at least one position measurement to produce at least one filtered position of the mobile device. The at least one filtered position may be adjusted based at least in part on mapping information to produce at least one adjusted position of the mobile device, with the mapping information pertaining to a constrained environment that corresponds to at least a portion of an interior of a building structure. Other example implementations are described herein.

CLAIM OF PRIORITY UNDER 35 U.S.C. §119

This application claims priority under 35 USC 119 to U.S. Provisional Application Ser. No. 61/295,575, filed 15 Jan. 2010, and entitled “Low Complexity Method for Improved Tracking of a Mobile Station over a Constrained Map,” which is assigned to the assignee hereof and which is incorporated herein by reference.

### BACKGROUND

1. Field

The subject matter disclosed herein relates to using filtering with mobile device positioning in a constrained environment.

2. Information

Humankind has always struggled to journey from point “A” to point “B”. In ancient times, individuals in unfamiliar territory wandered around without guidance or perhaps risked asking local inhabitants for directions. People eventually developed maps to provide written guidance for reaching a desired destination. As literacy and the availability of paper became more common, more people gained the ability to use maps during their travels.

Maps began to be available in electronic form during the 20^{th} century. With the advent of the internet, people could electronically access maps of essentially any place in the world. Web mapping services could also provide directions from point “A” to point “B”. These web-based mapping directions were relatively static. With the invention of satellite-positioning system (SPS) technology and ever-smaller electronic devices, however, so-called turn-by-turn directions could be provided dynamically as people journeyed toward their destination.

Unfortunately, these electronic maps and web-based mapping services focus on providing directions in the outdoors, such as from one postal address to another postal address. Similarly, turn-by-turn directions have traditionally been limited to roadways. An ability to provide analogous mapping and directional services indoors is currently lacking.

### BRIEF DESCRIPTION OF THE FIGURES

Non-limiting and non-exhaustive aspects, features, etc. will be described with reference to the following figures, wherein like reference numerals refer to like parts throughout the various figures.

FIG. 1 is a block diagram illustrating an example of a mobile device moving through various positions while its trajectory is being estimated using first and second example approaches according to an implementation.

FIG. 2 is a schematic diagram of an example constrained environment and associated mapping information according to an implementation.

FIG. 3 is a block diagram including at least one filter, example mapping information, and an adjustment operation to produce an adjusted position from a filtered position according to an implementation.

FIG. 4 is a schematic diagram of a constrained environment in which adjusted positions may be produced from filtered positions via example adjustment operations according to an implementation.

FIG. 5 is a flow diagram illustrating an example method for using filtering with mobile device positioning in a constrained environment according to an implementation.

FIG. 6 is a block diagram of example forking operations to generate an adjusted filter from an unadjusted filter according to two implementations.

FIG. 7 is a block diagram of an example pool of filters that may be created by generating adjusted filters with one or more forking operations according to an implementation.

FIG. 8 is a flow diagram illustrating an example method for pruning filters from a pool of filters according to an implementation.

FIG. 9 is a flow diagram illustrating an example method for enforcing a maximum size for a pool of filters according to an implementation.

FIG. 10 is a flow diagram illustrating an example method for selecting one or more mobile device position values from a pool of filters according to an implementation.

FIG. 11 is a schematic diagram illustrating an example device, according to an implementation, that may implement one or more aspects of using filtering with mobile device positioning in a constrained environment.

### SUMMARY

For certain example implementations, a method may comprise obtaining at least one position measurement of a mobile device and filtering the at least one position measurement to produce at least one filtered position of the mobile device. The method may further comprise adjusting at least one filtered position based at least in part on mapping information to produce at least one adjusted position of the mobile device. Mapping information may pertain to a constrained environment that corresponds to at least a portion of an interior of a building structure. For certain example implementations, a device may comprise at least one memory to store instructions and one or more processors to execute the instructions and cause the device to obtain at least one position measurement of a mobile device. Execution of the instructions may further cause the device to filter the at least one position measurement to produce at least one filtered position of the mobile device and to adjust the at least one filtered position based at least in part on mapping information to produce at least one adjusted position of the mobile device, with the mapping information pertaining to a constrained environment that corresponds to at least a portion of an interior of a building structure. For certain example implementations, an apparatus may comprise: means for obtaining at least one position measurement of a mobile device; means for filtering the at least one position measurement to produce at least one filtered position of the mobile device; and means for adjusting the at least one filtered position based at least in part on mapping information to produce at least one adjusted position of the mobile device, with the mapping information pertaining to a constrained environment that corresponds to at least a portion of an interior of a building structure. For certain example implementations, an article may comprise at least one storage medium having stored thereon instructions executable by one or more processors to: obtain at least one position measurement of a mobile device; filter the at least one position measurement to produce at least one filtered position of the mobile device; and adjust the at least one filtered position based at least in part on mapping information to produce at least one adjusted position of the mobile device, with the mapping information pertaining to a constrained environment that corresponds to at least a portion of an interior of a building structure. It should be appreciated, however, that these are merely example implementations and, that other implementations are described herein and may be implemented without deviating from claimed subject matter.

### DETAILED DESCRIPTION

Reference throughout this Specification to “a feature,” “one feature,” “an example,” “one example,” and so forth means that a particular feature, structure, characteristic. etc. described in connection with the feature and/or example may be relevant to at least one feature and/or example of claimed subject matter. Thus, the appearances of a phrase such as “in one example,” “an example,” “in one feature,” “a feature,” “in an example implementation.” “for certain example implementations,” and so forth in various places throughout this Specification are not necessarily all referring to the same feature, example, and/or example implementation. Furthermore, the particular features, examples, structures, characteristics, etc. may be combined in one or more example implementations, example systems, and so forth.

As indicated above, electronic maps and web-based mapping services are not usually offered for building structures. Similarly, turn-by-turn directions are not typically provided for indoor environments. However, many indoor spaces are sufficiently large, complex, and/or difficult to navigate such that navigational information may be beneficial, e.g., to a user of a mobile device. In order to provide navigational information to or other location-based services (LBS) for a mobile device in an indoor environment, a location of a mobile device may be acquired.

At least most techniques for determining a position (e.g., of a mobile device) involve some level of error, indeterminability, or other inaccuracy. Such inaccuracy may be reduced, for example, by combining location-determining techniques, considering other position-related data, and/or filtering position data. By way of example only, a filtered trajectory of a mobile device may be used to fine tune or otherwise modify a measured position estimate. In other words, knowledge of an (estimated) trajectory of a mobile device may be utilized to improve tracking and/or positioning estimates.

Utilizing knowledge of a model of likely trajectories of a mobile device may improve tracking and/or positioning estimates. Trajectory smoothing techniques, such as Kalman filtering, may achieve this by keeping track of a speed (and an acceleration) of the motion of a targeted mobile device in addition to positions of the targeted mobile device. Kalman filtering is an example of a relatively efficient recursive estimator that may find an optimal a posteriori estimate in a linear Gaussian dynamic system. However, fundamental restrictions with Kalman filters and many other efficient smoothing techniques can make it difficult to additionally incorporate map information, such as feasibility and/or routability information for a constrained environment, into such filtering techniques in a systematic and useful manner. For example, forcing a state of a Kalman filter to respect non-linear and/or non-Gaussian restrictions often causes instability or convergence to a wrong trajectory.

By way of example, a Kalman filter may keep track of a state vector including a position (x,y) as well as a velocity having velocity components (Vx,Vy). A linear system model may be used to describe transitions from one state to another. The following example position and velocity equations may be used:

x(t2)=x(t1)+Vx*(t2−t1)+Wx

y(t2)=y(t1)+Vy*(t2−t1)+Wy

Vx(t2)=Vx(t1)+Ux

Vy(t2)=Vy(t1)+Uy,

where Wx, Wy, Ux, and Uy are zero-mean Gaussian random variables, with variances that potentially depend on an elapsed time (t2−t1).

Additionally, another linearized Gaussian model may be used to include a posteriori measurements about a location of a targeted object. In cases using ranging (e.g., with round-trip time (RTT) measurements, received signal strength indicator/indication (RSSI) measurements, etc.), such cases are inherently non-linear because the contours of equal measurements are circular or otherwise curved. Furthermore, noise is usually non-Gaussian. An Extended Kalman filter (EKF) may linearize this system, which can then be used with Kalman filtering updates. An EKF may optionally iterate a number of times for better linearization and convergence to an “optimal” estimate under a given model.

Neither a Kalman filter nor an EKF, as described above, uses map information pertaining to a constrained environment. Moreover, there is no readily apparent way to introduce map information into a position filtering analysis. A relatively naïve incorporation of map information into a filter may be achieved by altering a state of the filter. For example, a filtered output state may be forced to fall onto a closest feasible point, which enforcement thereby results in a “forced filter.” This will not typically be a viable solution, unfortunately, because forcing a filter often ultimately causes instability and/or convergence to an incorrect trajectory.

In contrast, for certain example implementations that are described herein, a method may comprise obtaining at least one position measurement of a mobile device and filtering the at least one position measurement to produce at least one filtered position of the mobile device. The at least one filtered position may be adjusted based at least in part on mapping information to produce at least one'adjusted position of the mobile device. Mapping information may pertain to a constrained environment, such as an indoor environment with walls and/or other obstacles. By adjusting a filtered output of a filter based at least partly on mapping information instead of adjusting an internal state of a single filter, such a single filter need not become unstable or converge to an incorrect trajectory.

Moreover, in other example implementations, one or more filters may have their state adjusted based at least partly on mapping information if, e.g., a pool of filters is maintained. Such a pool of filters may continue to include at least one unadjusted filter that is likely to remain stable. With regard to adjusted filters of such a pool of filters, those that become unacceptable based on a predetermined criterion may be removed. If a pool of filters becomes too large, one or more adjusted filters may be removed. A filtered output value that is to be further used with respect to a mobile device may be selected from a pool of filters and/or determined from multiple positions produced by the pool of filters. Position accuracy and/or tracking of mobile devices may thus be enhanced and/or improved. Using such enhanced positions and/or improved tracking, navigational information and/or a LBS may be provided to a user (e.g., to a mobile device thereof).

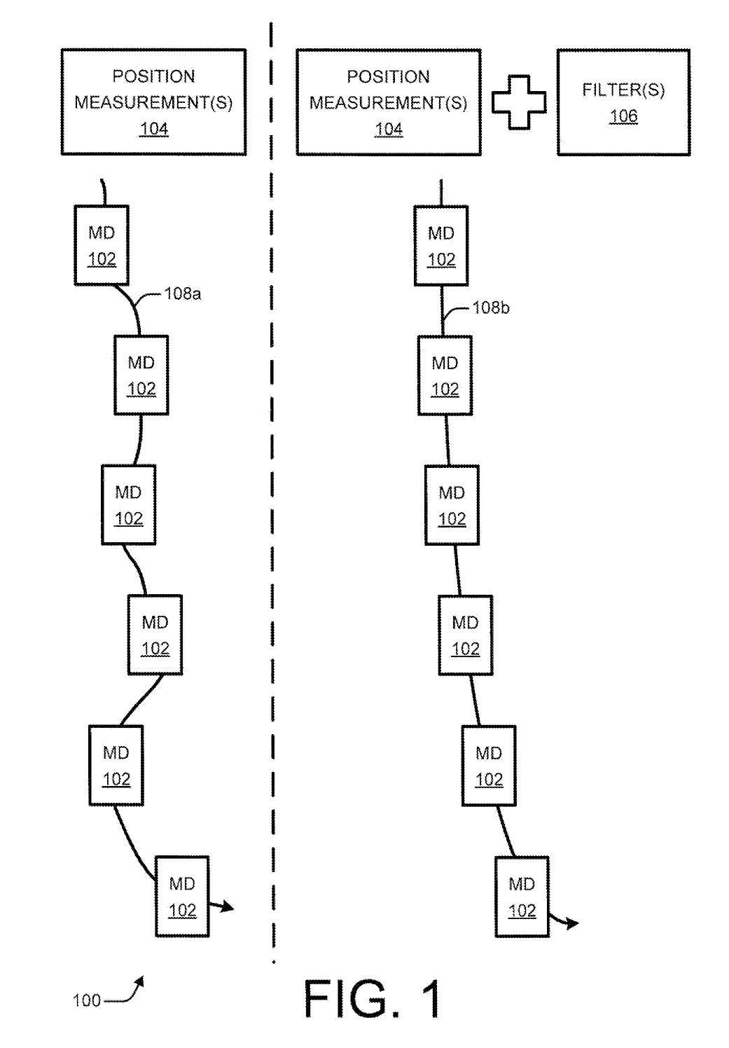

FIG. 1 is a block diagram 100 illustrating an example of a mobile device moving through various positions while its trajectory is being estimated using a first approach and a second example approach according to an implementation. As illustrated, block diagram 100 may include at least one mobile device 102, one or more position measurements 104, one or more filters 106, and at least two trajectories 108a and 108b. As shown, trajectory 108a appears to be uneven and haphazard. In contrast, trajectory 108b appears to be smoother and steadier.

Movement of a mobile device 102 may form a trajectory. A trajectory may be considered a collection of trajectory points (e.g., points in space and time) comprising respective positions of a mobile device 102 at corresponding respective times. Transitions may represent changes between trajectory points. For certain example implementations, using one or more filters 106 may smooth an apparent trajectory 108 of a mobile device 102.

On a left side of block diagram 100, mobile device 102 appears to be making a trajectory 108a. One or more position measurements 104 may be used to provide data for a position estimation of a mobile device 102. A position measurement 104 may comprise, by way of example but not limitation, at least one detected item of data measurement relating to a position of an associated mobile device. Because position measurements typically include at least some level of error, imprecision, and/or inaccuracy, a mobile device that is actually moving in a smooth trajectory may appear to be following a weaving and uneven trajectory, such as trajectory 108a.

On a right side of block diagram 100, mobile device 102 appears to be making a trajectory 108b. To at least partially accommodate or otherwise account for inherent inaccuracies and/or uncertainties of position measurements 104, such position measurements may be filtered by one or more filters 106. A filter 106 may factor in a history of previous estimated positions, velocities, and/or accelerations when determining a current position. A filter 106 may incorporate such historical information and/or enforce a mobility model, which may express a distance and/or direction that a mobile device is likely to travel. Consequently, a trajectory that appears to be somewhat meandering (e.g., trajectory 108a) may be smoothed such that it is likely closer to an actual real-world trajectory (e.g., trajectory 108b).

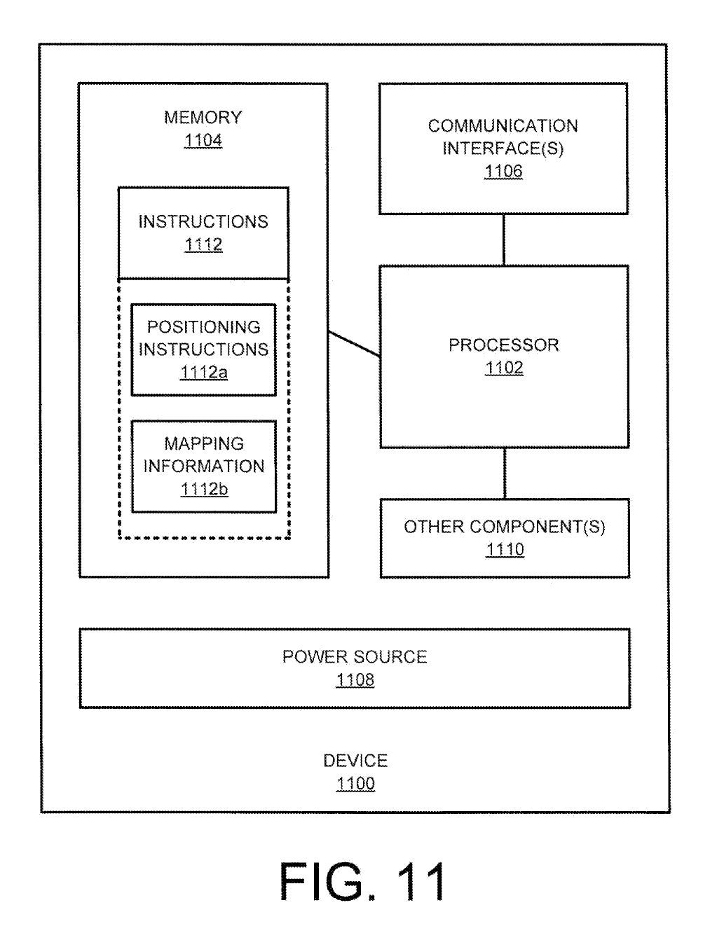

Examples of mobile devices 102 may include, but are not limited to, a mobile station, a mobile phone, a netbook, a laptop, a tablet computer, an entertainment appliance, some combination thereof, and so forth, just to name a few examples, or it may comprise any mobile device with wireless measurement capabilities and/or with other motion-related sensors. Additional mobile device examples are described herein below with particular reference to FIG. 11. However, claimed subject matter is not limited to any particular type, category, etc. of mobile device.

In certain example implementations, position measurements 104 may be acquired by and/or from one or more position detectors (not explicitly shown). Examples of position detectors may include, but are not limited to, Wi-Fi/WLAN access points, Worldwide Interoperability for Microwave Access (WiMAX) nodes, femtocells, cellular base stations and other cellular wireless nodes, SPS infrastructure (e.g., satellites pseudolites, etc.), a Bluetooth or other “short-range” wireless node. combinations thereof, and so forth. Such position detectors may also comprise and/or interact with a mobile device and/or components thereof to make one or more position-related measurements. With an example access point implementation, position measurements 104 may include, but are not limited to, RTT, RSSI, etc. data measurements of varying levels of accuracy. With an example SPS implementation, position measurements may include, but are not limited to, SPS coordinates of varying degrees of precision. Such one or more position related measurements may comprise and/or be combined so as to comprise at least one position measurement. However, other position detectors and/or position-related measurements may be implemented without departing from claimed subject matter.

Examples of filters 106 may include, but are not limited to, smoothing filters, Kalman filters, EKFs, sigma point Kalman filters, particle filters, combinations and derivatives thereof, and so forth. However, other types, categories, etc. of filters may be implemented without departing from claimed subject matter. A trajectory of a mobile device may be estimated by a mobile device, by a fixed device (e.g., a server, a communications node, etc.), another device or combination of devices, and so forth, just to name a few examples. Example devices generally are described herein below with particular reference to FIG. 11.

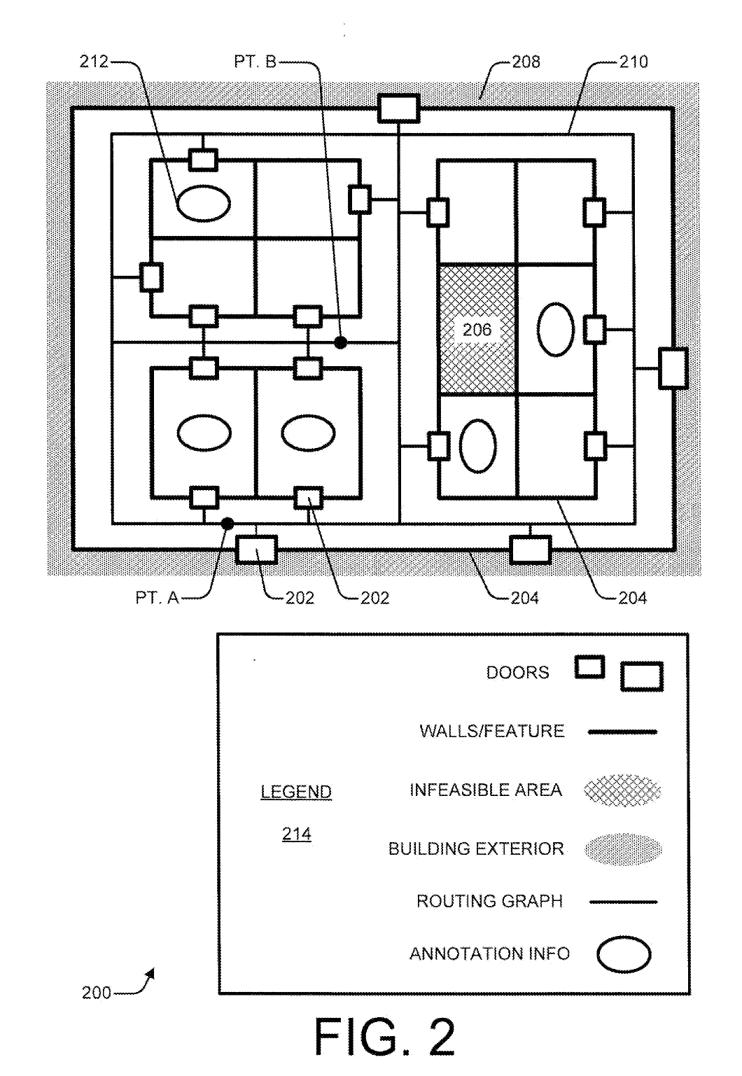

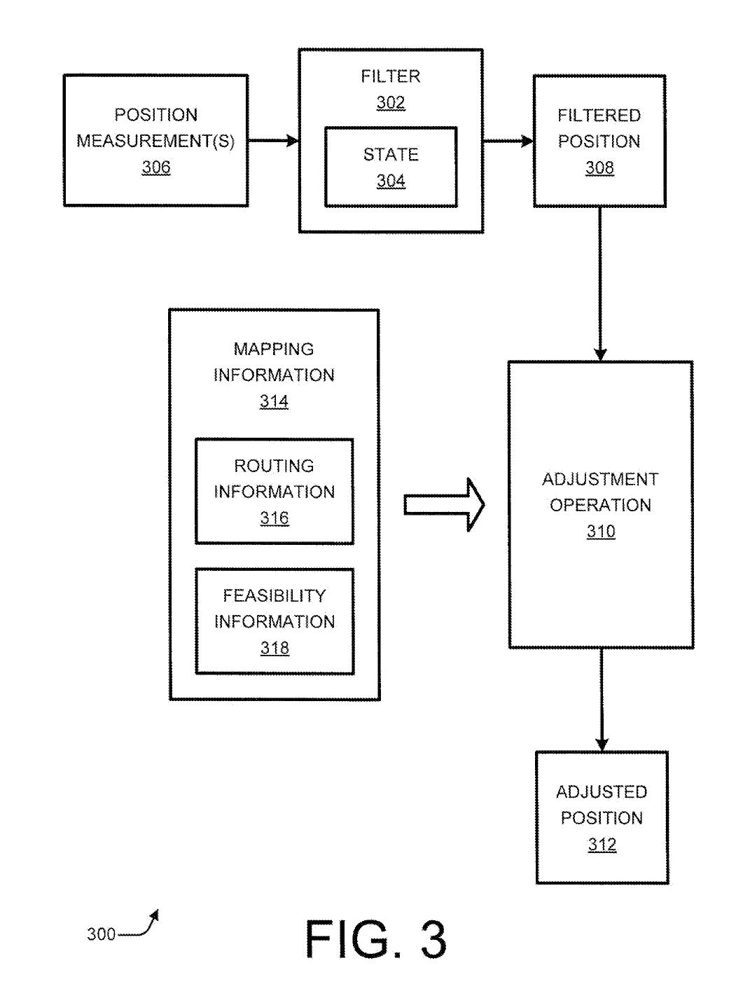

Although application of one or more filters 106 may likely improve an accuracy of mobile device positioning estimates, there is still likely, to be some level of error and/or imprecision. For certain example implementations as described herein, map information that may reflect environmental constraints on movement of a mobile device may further be incorporated into a process of making mobile device positioning estimates. Examples of map information are described herein below with particular reference to FIGS. 2 and 3.

FIG. 2 is a schematic diagram 200 of an example constrained environment and associated example mapping information according to an implementation. As illustrated, schematic diagram 200 includes a map of an indoor environment and a routing graph that has been created for the indoor environment. Indoor environments may include office buildings, apartment buildings/complexes, malls, airports, arenas, convention centers, stadiums, and so forth, just to name a few examples. An indoor environment may have walls, doors, columns, stairs, elevators, and so forth. These types of building features and other objects may restrict movement around an indoor environment. Indoor environments may also have open areas such as lobbies, common areas, entryways, rooms, and so forth, just to name few examples. Accordingly, because paths of movement for such an indoor environment may be restricted in some areas (although they may also be unrestricted in other, open areas), such an indoor environment may be an example of a constrained environment.

For certain example implementations, a routing graph with linked or otherwise associated annotation information may be used to provide navigational information. Navigational information may include, by way of example but not limitation, positioning information, directional information, turn-by-turn directions, and so forth. Such navigational information may facilitate travel from a point “A” to a point “B”. By way of example but not limitation, a routing graph with associated annotation information may be descriptive of feasible areas of a given map and indicate how traversal is possible from one position to another position. Such a routing graph and/or associated annotation information may comprise an example of routability information. For any given building, a routing graph may comprise a set of nodes and edges that depict feasible areas and traversable paths from one point in a building to another point. A traversable path may comprise, by way of example but not limitation, a path between any two points that is not blocked by a wall or other obstacle.

As shown in example schematic diagram 200, an example routing graph 210 has been created that may include linkages to annotation information 212 from building information that is descriptive of at least a portion of a building structure. Such building information may comprise data that is in any format. Building information may comprise a computer aided design (CAD) file, a drawing interchange format (DXF) file, an image file, some combination thereof, and so forth, just to name a few examples.

As illustrated, schematic diagram 200 may include external/internal doors 202, exterior/interior walls 204, at least one infeasible area 206, a building exterior area 208, a routing graph 210 and annotation information 212. Using routing graph 210, a navigational application and/or system may provide directional instructions for an individual to travel, for instance, from point “A” to point “B”. Although all such illustrated features are not explicitly denoted with reference numerals in FIG. 2 for the sake of visual clarity, a legend 214 indicates what building and navigational features are connoted by which particular drawing features. Also, although schematic diagram 200 generally and routing graph 210 specifically include certain example components as illustrated in FIG. 2 and described herein below, claimed subject matter is not so limited. Instead, given implementations may include more, fewer, and/or different components. For example, building information may omit door indications. Also, infeasible areas may not be identified. Furthermore, additional annotation information and/or additional types of such information may be linked to routing graph 210. Other alternatives and alternative components may be added, incorporated, omitted, changed, and so forth without deviating from claimed subject matter.

By way of example but not limitation, routing graph 210 may be indicative of a routing topology. Routing graph 210 may be retrieved (e.g., from memory, from a remote location, etc.) and/or created so as to correspond to a building structure of schematic diagram 200. To create a routing graph 210, a grid of points may be applied to building information. The building information may be explored using such an applied grid of points. By way of example but not limitation, possible locations on a map may be represented using a discrete set of grid points. This discreteness need not present a problem for an accuracy of an overall system because a granularity of an applied grid of points may be increased so as to exceed a desired level of precision.

As part of an example exploration of building information, autonomous areas may be determined. Autonomous areas may include rooms, hallways, a building exterior, and so forth, just to name a few examples. At least one autonomous area may be ascertained to comprise a building exterior area 208. One or more other autonomous areas may be determined to comprise an infeasible area 206. For example, an area without a door and/or an area without annotation information may be determined to be infeasible. On the other hand, autonomous areas that are reachable and/or that are associated with annotation information may be determined to comprise feasible areas (e.g., accessible rooms, hallways, etc.).

If doors are indicated in building information, one or more external doors 202 (e.g., the larger door rectangles in FIG. 2 representing exits and/or entrances for a building structure) may be determined if door(s) connect to and provide access to building exterior area 208. One or more internal doors 202 (e.g., the smaller door rectangles in FIG. 2) may be determined to provide access to other feasible areas, such as internal rooms, hallways, and so forth. If doors are not indicated in building information, point(s) of entry/exit for rooms, stores, or other zones may be determined based at least partly on corresponding annotation information 212 and a line projected from a point of annotation information for a given zone toward a hallway based at least partly on whether a hallway is adjacent to a wall defining a given zone, a combination thereof, and so forth, just to name a couple of examples.

Annotation information 212 may be linked to routing graph 210 to further enable navigational aid between and/or among different areas (e.g., rooms, zones, etc.) and/or another location-based service. Annotation information 212 may also provide information associated with a particular zone, such a lobby, an elevator bank, a dining location, and so forth, just to name a few examples. By way of example but not limitation, annotation information 212 may include room designations (e.g., “A”, “1.24”, etc.), room names (e.g., “Conference Room 1”, etc.), room purposes, (e.g., “Bathroom”, “Kitchen”, etc.), room residents or occupants (e.g., “Amy”, “Ray”, etc.), zone exhibitors (e.g., “Acme”, “AA Industrializing”, etc.), store owners (e.g., “Rugs-R-Us”, “Nicky's Nick-Knacks”, etc.), and so forth.

Routability information may comprise, for example, information that is capable of aiding and/or facilitating a determination of a route. By way of example but not limitation, routability information may include any one or more of the following: a routing graph 210, annotation information 212 (e.g., that is linked to a routing graph 210), general building information, indication(s) of feasible and infeasible areas, indications of traversable paths, any combination thereof, and so forth, just to name a few examples. A routing graph 210 may be used to plot a path from one point to another point, including from one annotated area to another annotated area. Mapping information may comprise routability information, building information, any portion or combination thereof, and so forth, just to name a few examples.

FIG. 3 is a block diagram 300 including at least one filter, example mapping information, and an example adjustment operation to produce an adjusted position from a filtered position according to an implementation. As illustrated, block diagram 300 may include one or more position measurements 306, at least one filter 302, one or, more filtered positions 308, at least one adjustment operation 310, one or more adjusted positions 312, and mapping information 314. As shown, a filter 302 may comprise state 304, and mapping information 314 may comprise routing information 316 and/or feasibility information 318.

For certain example implementations, a position measurement 306 may comprise any information that indicates a position of a mobile device. By way of example but not limitation, a position measurement 306 may comprise a position measurement 104 (of FIG. 1), a combination of position measurements 104, a fully or partially processed version of one or more position measurements 104, a combination thereof, and so forth. A position of a mobile device may be indicated in a local and/or a global coordinate system. A position measurement 306 may be applied to update filter 302. More specifically, a position measurement 306 may be filtered by filter 302 based at least partly on an internal state 304 to produce a filtered position 308. By way of example but not limitation, a filter 302 may perform trilateration while considering a history of positions. State 304 may represent, for example, a portion of filter 302 that models previous position measurement(s) 306, previous filtered position(s) 308 for filter 302, a combination thereof, and so forth. Thus, a state 304 may represent a history of one or more value(s) received and/or produced by filter 302, a history of estimated velocities and/or directions of movement of a mobile device, other information pertaining to a filtering process, and so forth, just to name a few examples.

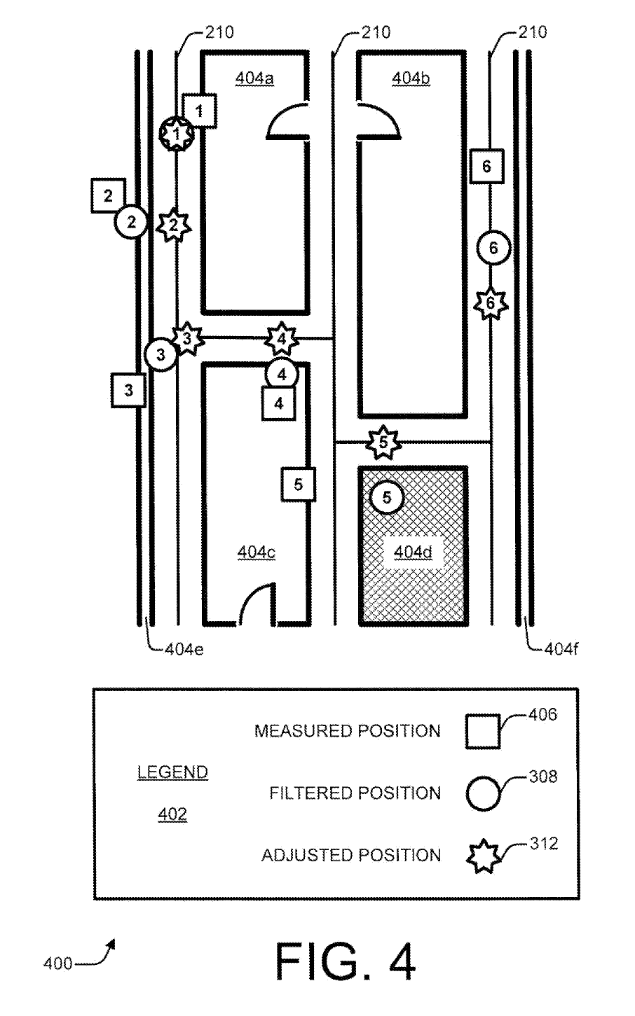

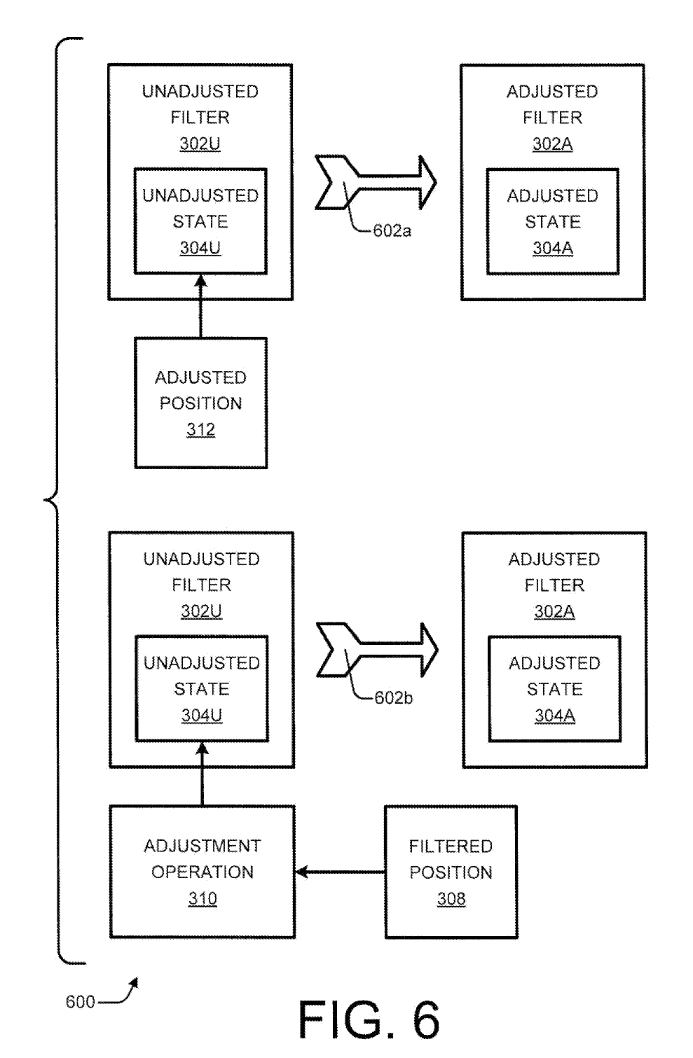

Filtered position 308 may be adjusted via adjustment operation 310 to produce adjusted position 312. By way of example but not limitation, adjustment operation 310 may produce adjusted position 312 responsive to filtered position 308 based at least partly on mapping information 314. Implementations for example adjustment operations 310 are described further herein below with particular reference to FIG. 4. Additionally and/or alternatively, adjustment operation 310 and/or adjusted position 312 may affect an internal state 304 of a filter 302. Such example implementations in which an internal state 304 of a filter 302 are adjusted are described further herein below with particular reference to at least FIG. 6.

For example implementations, mapping information 314 may comprise routing information 316, feasibility information 318, any combination thereof, and so forth, just to name a few examples. Routing information 316 may comprise, by way of example but not limitation, information that identifies one or more traversable paths between two or more points for a map area. Such information may further include data from which a length of traversable path may be computed. Feasibility information 318 may comprise, by way of example but not limitation, information that identifies which areas are feasible and whether one or more areas are infeasible. An area that is reachable by a mobile device, for instance, may be considered a feasible area. Mapping information 314, routing information 316, and feasibility information 318 are also described further herein above with particular reference to FIG. 2.

FIG. 4 is a schematic diagram 400 of a constrained environment in which adjusted positions may be produced from filtered positions via example adjustment operations according to an implementation. As illustrated, schematic diagram 400 may include a routing graph 210, measured positions 406, filtered positions 308, adjusted positions 312, a legend 402, and obstacles 404. Legend 402 indicates that for schematic diagram 400 measured positions 406 are represented by square shapes, filtered positions 308 are represented by circle shapes, and adjusted positions 312 are represented by star shapes.

For certain example implementations, schematic diagram 400 may include one or more obstacles 404a-404f. Obstacles 404 represent one or more objects that restrict movement of mobile devices. Obstacles 404 may, for instance, block a direct path between two points. Obstacles 404a, 404b, 404c, and 404d may comprise, for example, rooms that are formed from walls or other barriers. As shown in FIG. 4, at least obstacles (e.g., rooms) 404a, 404b, and 404c may include (e.g., internal) doors. As represented by cross-hatched shading, obstacle 404d may be indicated, for instance, as being an infeasible area (e.g., an area without a door). Obstacles 404e and 404f may comprise, for example, external walls of a building structure. As shown, no external doors are visible in schematic diagram 400. An example routing graph 210 is also represented by relatively thinner lines along multiple hallways/corridors. Measured positions 406 may correspond, by way of example but not limitation, to relatively more probable locations of one or more position measurements, which may be weighed by a relative likelihood derived from a probability distribution, prior to filtering.

To illuminate six example adjustment operations, each set of measured, filtered and adjusted positions is identified by a numeral from one (1) to six (6). With regard to a first (1) example adjustment operation, a first measured position is indicated by a square identified by a numeral one. An associated first filtered position is indicated by a circle identified by a numeral one, and an associated first adjusted position is indicated by a star identified by a numeral one. In this first example adjustment operation, the adjusted position is substantially equivalent to the filtered position, as is indicated by the circle and star being co-located with one another. This may represent a situation in which no adjustment operation is performed or an adjustment amount is substantially zero.

With regard to a second (2) example adjustment operation, a second measured position is located outside a building, and a second filtered position is located along an external side of an exterior wall 404e. With reference to mapping information (e.g., feasibility information), it is apparent that a mobile device is not actually located within an exterior wall 404e and cannot be located outside the building if the modeled environment represents an upper floor. With reference to mapping information (e.g., routability information), it is apparent that a mobile device cannot have moved outside of the building between positions 1 and 2 given that no external doors are proximate to the previous location. Hence, second filtered position may be adjusted by. “pushing” it to a feasible position (e.g., into a hallway) such as second adjusted position. By way of example only, the filtered position may be pushed to a closest feasible position and/or a closest feasible position in the middle of a corridor to produce the adjusted position.

With regard to a third (3) example adjustment operation, a third measured position is located along exterior wall 404e, and a third filtered position is located just inside the building along an internal side of exterior wall 404e. With reference to mapping information, it is elected to adjust third filtered position towards a center of a hallway and/or an intersection that is proximate to the third filtered position. Thus, a third adjustment operation may produce a third adjusted position as shown.

With regard to a fourth (4) example adjustment operation, a fourth measured position is located within room 404c, and a fourth filtered position is also located within room 404c. With reference to mapping information (e.g., feasibility information), it is apparent that room 404c is a feasible area. However, with further consideration of mapping information (e.g., routability information), it may be determinable that fourth filtered position is not reachable by a tracked mobile device inasmuch as the illustrated door to room 404c is not reachable by the mobile device at a current and/or reasonable speed. Accordingly, based at least partly on such routability information, fourth filtered position may be pushed to a fourth adjusted position, such as a proximate position that is likely to be reachable by a tracked mobile device with the corridor.

With regard to a fifth (5) example adjustment operation, a fifth measured position is located within a room 404c, and a fifth filtered position is located within an area 404d. With reference to mapping information (e.g., feasibility information), it is apparent that area 404d is indicated to be an infeasible area. It may therefore be assumed that a mobile device cannot gain access to area 404d. Hence, fifth filtered position may be adjusted by “pushing” it to a feasible position (e.g., into a proximate hallway) such as a fifth adjusted position as shown.

With regard to a sixth (6) example adjustment operation, a sixth measured position and a sixth filtered position are both located along a (feasible) hallway. With reference to mapping information (e.g., routability information), it may be determinable that sixth filtered position is not reachable by a mobile device traveling at a reasonable/likely speed and/or at a current speed of a tracked mobile device. A distance traveled may be determined using a shortest path algorithm that may be run, for example, on a connectivity graph of a map in which edges denote possible transitions on the map and in which each edge is weighted by its length. A current speed may be determined, for example, based on a speed estimated at the fifth, position, based on an average of speeds over a number of previous positions, and so forth. Accordingly, based at least partly on such routability information and an expected speed, sixth filtered position may be pushed to a sixth adjusted position, such as a feasible position along a current trajectory that is likely to be reachable by the tracked mobile device at the expected speed.

Although six example scenarios and corresponding example adjustment operations are described above, claimed subject matter is not so limited. Other adjustment operations may additionally and/or alternatively be implemented. It should be noted that data values representing real-world variables, quantities, amounts, degrees, etc. typically include some level of inaccuracy. In other words, data values that are derived from real-world measurements may be susceptible to some level of error and/or imprecision. As such, many data values representing real-world phenomena may be considered to be estimates. Accordingly, position measurements (and/or measured positions corresponding thereto), filtered positions, other positions, times and timings, velocities of movement, directions of movement, trajectories, etc. may be estimated values, probabilistically-distributed values, any combination thereof, and so forth, just to name a few examples. They may be measured, calculated, or otherwise determined to a desired level of accuracy and/or a possible level of accuracy given available technology, resources to be applied, and so forth. Although not explicitly referred to as estimates or probabilistic distributions herein, it is to be understood that such data values that are used herein may be estimated and/or probabilistically-distributed versions of corresponding real-world variables in certain example implementations.

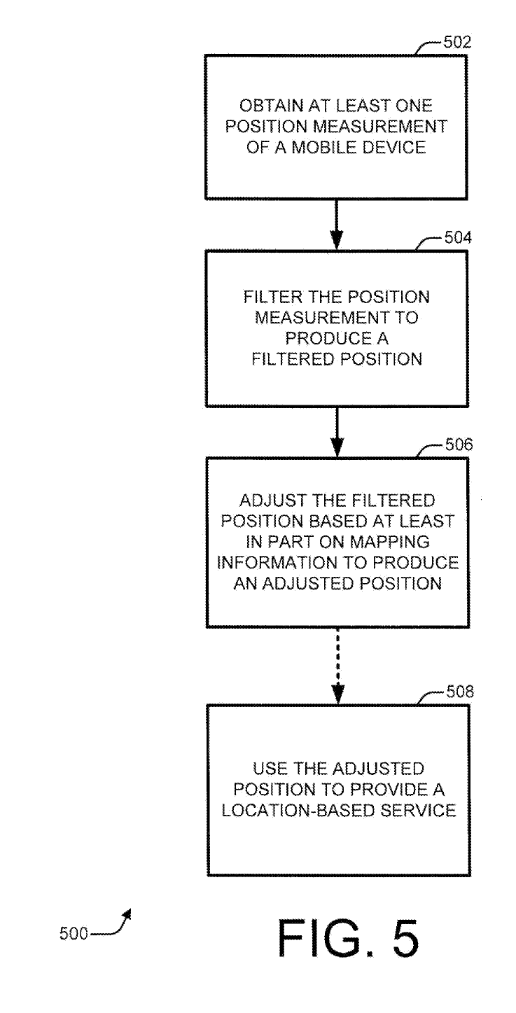

FIG. 5 is a flow diagram 500 illustrating an example method for using filtering with mobile device positioning in a constrained environment according to an implementation. As illustrated, flow diagram 500 may include four operational blocks 502-508. Although operations 502-508 are shown and described in a particular order, it should be understood that methods may be performed in alternative manners (including with a different number of operations) without departing from claimed subject matter. Also, operations of flow diagram 500 may be performed so as to be fully or partially overlapping one another. Additionally, although the description below references particular aspects and features illustrated in certain other figures (e.g., FIGS. 1-4), methods may be performed with other aspects and/or features.

For certain example implementations, at operation 502, at least one position measurement of a mobile device may be obtained. For example, one or more position measurements 306 may be obtained from and/or in conjunction with one or more position detectors. For instance, a position measurement 306 (of FIG. 3) may comprise, be derived from, etc. one or more position measurements 104 (of FIG. 1).

At operation 504, the at least one position measurement may be filtered to produce at least one filtered position. For example, one or more position measurements 306 may be filtered by at least one filter 302 to produce one or more filtered positions 308. At operation 506, the at least one filtered position may be adjusted based at least in part on mapping information to produce at least one adjusted position. For example, at least one adjustment operation 310 may be applied to one or more filtered positions 308 to produce one or more adjusted positions 312 based at least partly on mapping information 314 (e.g., routing information 316 and/or feasibility information 318, etc.). For instance, at least one example adjustment operation as described herein above with particular reference to FIG. 4 may be applied to at least one filtered position to produce at least one adjusted position. Mapping information 314 may pertain, for instance, to a constrained environment in which movement of a mobile device may be restricted by one or more obstacles 404.

At operation 508, at least one adjusted position may be used to provide a location-based service. For example, one or more adjusted positions 312 may be used to provide a location-based service (LBS). Additionally and/or alternatively, at least one filtered position, which is produced by an adjusted filter (e.g., as described herein below with particular reference to FIG. 6), may be used to provide a location-based service. Examples, of location-based services may include, but are not limited to, routing, positioning, position filtering, navigation, incentives applications, search, combinations thereof, and so forth. Navigational information (e.g., turn-by-turn directional instruction(s), directions from one location to another location, etc.) may be provided by presenting them to a user (e.g., visually and/or aurally), by transmitting them to a mobile device, some combination thereof, and so forth, just to provide a few examples. A location-based service may be provided at any time. For, instance, one may be provided while a trajectory of a mobile device is being estimated. An LBS may also be provided while a trajectory of a mobile device is not currently being estimated. Operations 502-506 and/or 502-508 may be repeated as new position measurement(s) are obtained.

In example implementations, a single (unadjusted) filter may be maintained and updated with position measurements. A filtered position output of a single filter may be adjusted to comport with map information, and such an adjusted position may be used as a “best” position estimate. Such a process need not alter an internal state of a single filter. Hence, a single filter with such a process may not become biased over time. Nevertheless, using map information to adjust filtered positions (e.g., finding a closest feasible point) may improve a quality of an estimated position. For example, if an unadjusted filter predicts a position outside of a balcony of a building, then a close-by feasible point may be output instead. Similarly, if it is determined that a mobile device is in motion in a corridor (e.g., by using additional sensors and/or after inference based on movement behavior of a user in a corridor as opposed to that inside of a room), then an unadjusted position prediction in an office area may be pushed to a corridor location.

Alternatively, instead of a single filter, multiple filters may be maintained in a pool of filters and updated with current position measurements at different epochs. In example implementations, a pool of at most n separate filters may be maintained, with n being a positive integer. At any estimation epoch, an output from one or more of the filters may be selected for use as a current overall position estimate. A maximum number n of filters in a pool of filters may be chosen appropriately to achieve a desired trade-off between accuracy and complexity of the resulting system.

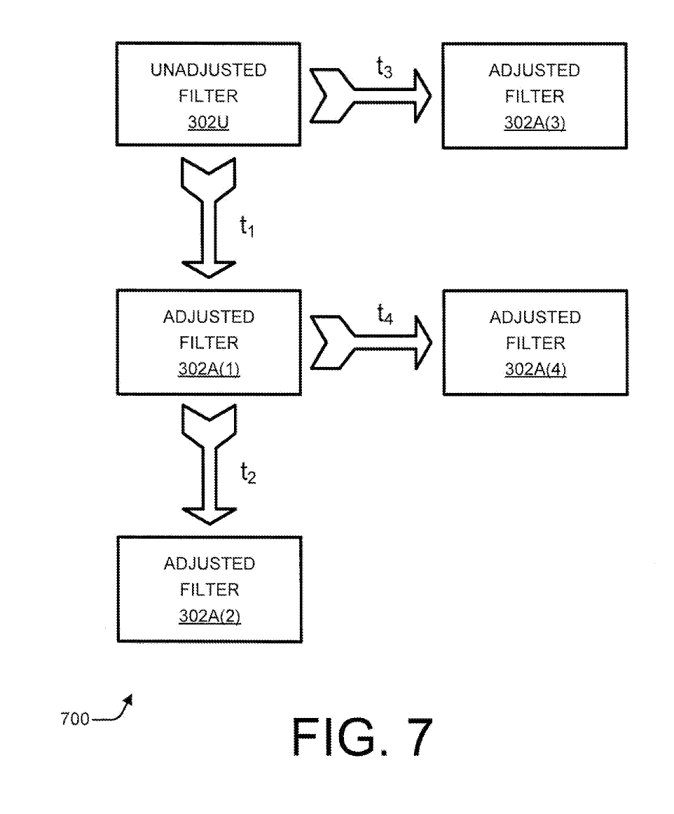

For an example implementation, a pool of filter(s) may include at least one unadjusted filter. At a measurement epoch, if an updated output of a given filter in a filter pool fails to comport with map information, then an adjusted version of that filter, wherein an internal state of such a filter is adjusted in a way that a filtered output from the filter comports with map information, may be forked and added to the pool. By way of example only, a predicted position may be considered to comport (e.g., match, etc.) with map information if such a predicted position is feasible and can be reached using a feasible velocity on the map from a previous predicted position. As noted herein above and described further herein below, a forking operation may involve altering an internal state of a filter to an adjusted state (e.g., a closest or most likely position that is allowed given map information). Example forking operations are described further herein below with particular reference to FIG. 6. Example pools of filters are described further herein below with particular reference to FIG. 7.

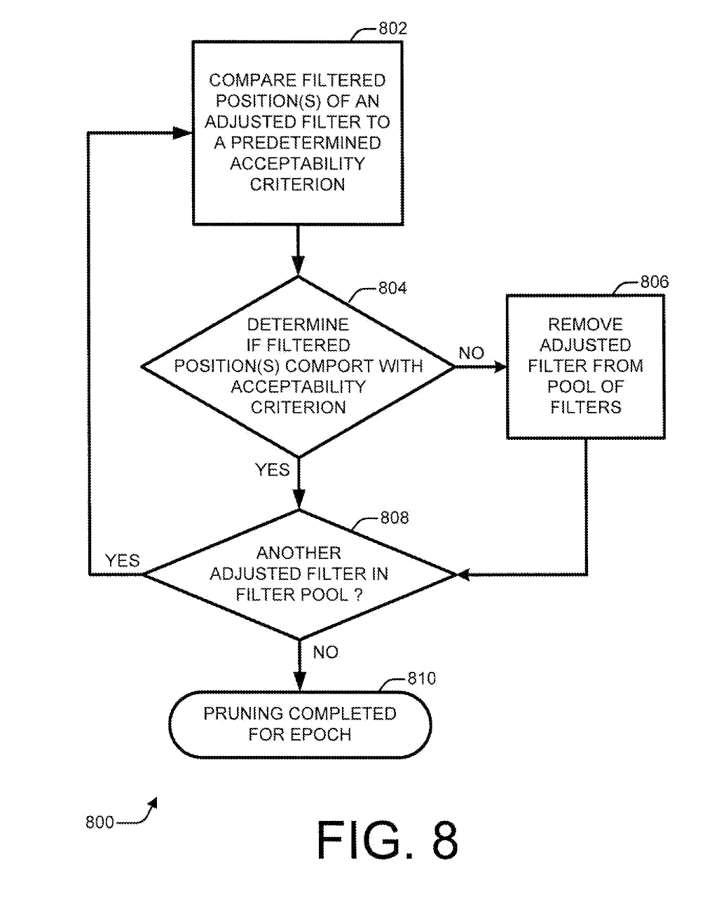

In example implementations, a pruning mechanism may be used to remove one or more filters if such filters fail to meet an acceptability criterion. For example, apparently unreliable filters may be removed by comparing adjusted filters to at least one unadjusted filter, which is likely to be more reliable over time. Such a pruning mechanism may prevent accumulation of bias in the adjusted filters of a pool of filters. For example, if an exponentially-weighted moving average (EWMA) of distances between a particular adjusted filter and an original unadjusted filter exceeds a first predetermined threshold, then that particular adjusted filter may be removed from a pool of filters. Alternatively or additionally, if an EWMA of an adjustment correction amount to a given adjusted filter exceeds a second predetermined threshold, then that given adjusted filter may be removed from a pool of filters. Example methods for pruning a pool of filters are described further herein below with particular reference to FIG. 8.

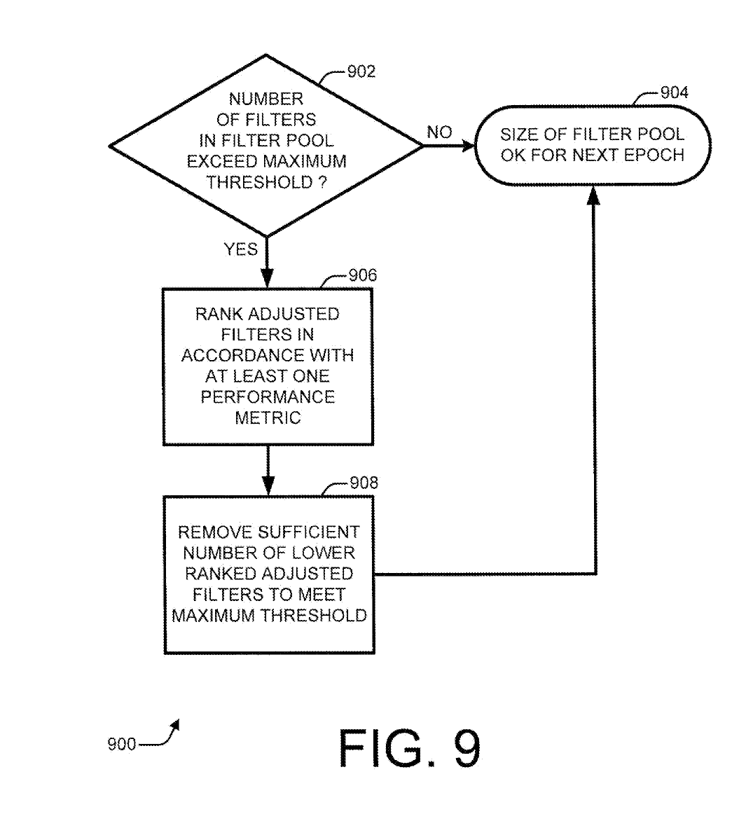

In example implementations, after processing filters in a pool of filters as described above, if a size of the filter pool exceeds a predefined number n of allowed filters, then one or more filters may be removed. Selection of filter(s) to be removed may involve ranking them according to at least one metric of a utility of each filter. In an example implementation, at each epoch, at least one filter that has been adjusted during a current epoch and at least one filter that has not been adjusted during the current epoch may be maintained in a pool of filters. In addition, an original unadjusted filter may be maintained in a pool of filters to keep an unbiased filter available for a baseline comparison with adjusted filters. Example methods for enforcing a maximum size for a pool of filters are described further herein below with particular reference to FIG. 9.

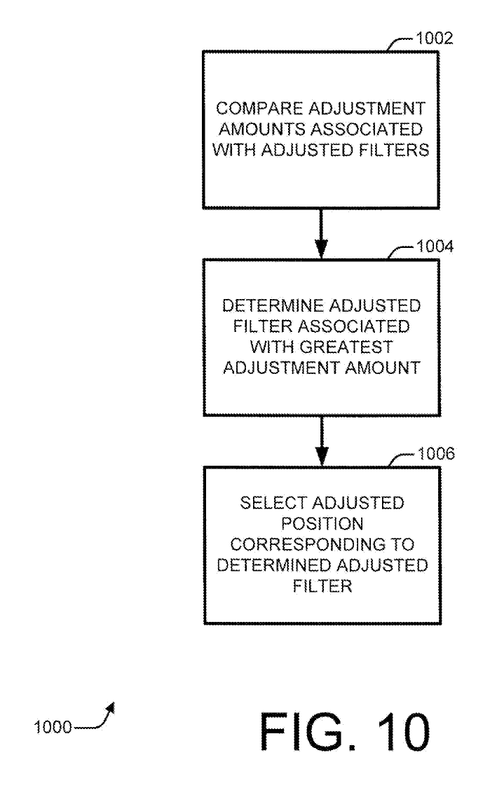

In example implementations, an overall position estimate of a system for an estimation epoch may be selected or otherwise determined as an estimate from a filter in a pool of filters. For instance, a filter that is a most aggressively-adjusted filter, which remains in a filter pool (e.g., that is not deemed unreliable), may be selected to produce an adjusted position to be used as an overall position estimate. Example methods for selecting one or more output positions from a pool of filters are described further herein below with particular reference to FIG. 10. Alternatively, multiple adjusted positions may be combined (e.g., average, weighted average, etc.) to produce an overall position estimate for an epoch.

FIG. 6 is a block diagram 600 of example forking operations to generate an adjusted filter from an unadjusted filter according to two example implementations. As illustrated, block diagram 600 may include an unadjusted filter 302U, an adjusted filter 302A, and an adjusted position 312 that may be involved in an example forking operation 602a. Block diagram 600 may further include an unadjusted filter 302U, an adjusted filter 302A, an adjustment operation 310, and a filtered position 308 that may be involved in an example forking operation 602b. Unadjusted filter 302U may comprise an unadjusted state 304U. Adjusted filter 302A may comprise an adjusted state 304A. An unadjusted filter 302U may be updated over time with position measurements to facilitate a position estimation operation over a trajectory (e.g., to implement a smoothing of a trajectory) in accordance with one or more models. Such updating may therefore implicitly change an internal state of an unadjusted filter 302U without adjusting it. In other words, such updating may implicitly change an internal state of an unadjusted filter 302U without forcing its state to a particular value or set of values in an “unnatural” manner.

For certain example implementations in accordance with forking operation 602a, unadjusted state 304U of unadjusted filter 302U may be set based at least partly on adjusted position 312 to generate adjusted filter 302A having adjusted state 304A. For example, adjusted filter 302A having adjusted state 304A may be generated from unadjusted filter 302U by setting (e.g., forcing, establishing, etc.) unadjusted state 304U to adjusted position 312 to generate adjusted state 304A. An adjusted filter may thus comprise a forced filter. Alternatively, unadjusted state 304U may be nudged toward adjusted position 312 to generate adjusted filter 302A having adjusted state 304A. By changing an internal state 304 of a filter 302, a historical “memory”, and hence future operations, of filter 302 may be changed as well. For certain example implementations in accordance with forking operation 602b, unadjusted state 304U of unadjusted filter 302U may be set based at least partly on an adjustment operation 310. By way of example but not limitation, adjustment operation 310 may adjust unadjusted state 304U to generate adjusted state 304A responsive to filtered position 308 based at least partly on mapping information 314 (of FIG. 3) using, e.g., an adjusted position 312 without necessarily producing a separately instantiated adjusted position 312.

By way of example only, a forking operation 602a and/or 602b may result in keeping both an unadjusted filter 302U (or any spawning filter 302 from which a new filter is generated) and an adjusted filter 302A. However, claimed subject matter is not so limited. For instance, a spawning filter (e.g., an adjusted or unadjusted filter) may alternatively be removed from a pool of filters while a new adjusted filter 302A is kept (e.g., instead of keeping both filters as in a forking operation).

FIG. 7 is a block diagram of an example pool of filters 700 that may be created by generating adjusted filters with one or more forking operations according to an implementation. As illustrated, pool of filters 700 may comprise multiple filters 302. Such multiple filters 302 may be maintained by updating them with at least one current position measurement at a current epoch. For certain example implementation, pool of filters 700 may include at least one unadjusted filter 302U and one or more adjusted filters 302A. An adjusted filter 302A may be generated from an unadjusted filter 302U or an adjusted filter 302A using, for example, a forking operation 602 (e.g., of FIG. 6). An adjusted filter 302A may also be generated for a pool of filters using an operation in which a spawning filter is not maintained within the pool of filters.

For certain example implementations in which a pool of filters is built and/or maintained, multiple adjusted filters 302A may be generated at different times. At a first time epoch (t1), an adjusted filter 302A(1) may be generated from an unadjusted filter 302U. At a second time epoch (t2), an adjusted filter 302A(2) may be generated from adjusted filter 302A(1). At a third time epoch (t3), an adjusted filter 302A(3) may be generated from unadjusted filter 302U. At a fourth time epoch (t4), an adjusted filter 302A(4) may be generated from adjusted filter 302A(1).

As shown by adjusted filters 302A(1) and 302A(3), an unadjusted (e.g., original) filter 302U may fork multiple filters at different times (epochs t1 and t3). Similarly, as shown by adjusted filters 302A(2) and 302A(4), an adjusted filter 302A(1) may also fork multiple filters at different times (epochs t2 and t4). Although not so illustrated, multiple filters 302 may fork multiple adjusted filters 302A during a single epoch. For example, adjusted filters 302A(2) and 302A(3) may be generated during a single epoch. Additionally, a single filter 302 may fork two or more adjusted filters 302A during a single epoch.

Multiple unadjusted filters 302U may also be present within a pool of filters. For example, two or more unadjusted filters 302U of different filter'types (e.g., a Kalman filter, an EKF, etc.) may be maintained within a pool of filters. Example approaches to pruning filter pools, enforcing a maximum size of a filter pool, selecting an overall output position estimate, and so forth are described herein below with particular reference to FIGS. 8-10.

FIGS. 8, 9, and 10 are flow diagrams 800, 900, and 1000, respectively, that illustrate different example methods and are described herein below. As illustrated, flow diagrams 800-1000 include a number of operational blocks. Although such operations are shown and described in a particular order, it should be understood that methods may be performed in alternative manners (including with a different number of operations) without departing from claimed subject matter. Also, operations of flow diagrams 800-1000 may be performed so as to be fully or partially overlapping one another. Additionally, although the description below references particular aspects and features illustrated in certain other figures, methods may be performed with other aspects and/or features.

FIG. 8 is a flow diagram 800 illustrating an example method for pruning filters from a pool of filters according to an implementation. As illustrated, flow diagram 800 may include five operational blocks 802-810. For certain example implementations, at operation 802, one or more filtered position(s) of an adjusted filter may be compared to a predetermined acceptability criterion. Such an adjusted filter may be part of a pool of filters. By way of example but not limitation, such a predetermined acceptability criterion may be based at least partially on one or more filtered positions produced by an unadjusted filter, which may be used as a baseline.

More generally, a predetermined acceptability may be based, at least partly on an average of filtered positions across a number of adjusted filter(s), on a size of at least one adjustment made by an adjusted filter in a current epoch and/or over a number of past epochs, on one or more filtered positions of an unadjusted filter, some combination thereof, and so forth, just to name a few examples. More specifically, but by way of example only, if a moving average (e.g., an exponentially-weighted moving average (EWMA)) of distances between a particular adjusted filter and an original unadjusted filter exceeds a first predetermined threshold, then that particular adjusted filter may be removed from a pool of filters. Alternatively or additionally, if a moving average (e.g., an EWMA) of an adjustment correction amount to a given adjusted filter in a single epoch or over a number of epochs exceeds a second predetermined threshold, then that given adjusted filter may be removed from a pool of filters.

At operation 804, it may be determined whether the one or more filtered position(s) comport with an acceptability criterion. If not, then at operation 806 the corresponding adjusted filter may be removed from a pool of filters. A filter may be removed from a pool of filters by jettisoning, deleting, deactivating, discarding, deallocating, cancelling, etc. the filter. On the other hand, if the one or more filtered position(s) are determined to comport with an acceptability criterion, then it may be determined at operation 808 whether another adjusted filter is to be analyzed in the pool of filters. If there are more adjusted filters to analyze, then the method of flow diagram 800 may continue at operation 802. If each adjusted filter in the pool of filters has been analyzed for a current epoch, then pruning may be completed for the current epoch at operative block 810.

FIG. 9 is a flow diagram 900 illustrating an example method for enforcing a maximum size for a pool of filters according to an implementation. As illustrated, flow diagram 900 may include four operational blocks 902-908. For certain example implementations, at operation 902, it may be determined whether a number of filters in a pool of filters exceeds a predetermined maximum size threshold. If not, then at operation 904 it may be determined that a current size of the pool of filters is permissible for a next epoch.

If a number of filters in a pool of filters does exceed a predetermined maximum size threshold (as determinable at operation 902), then at operation 906 multiple adjusted filters of the pool of filters may be ranked in accordance with at least one performance metric. Such a performance metric may be based at least partly on a current amount of adjustment for a given adjusted filter, an average amount of adjustment over a number of epochs for a given adjusted filter, a comparison of position(s) between a given adjusted filter and an unadjusted filter, some combination thereof, and so forth, just to name a few examples. At operation 908, a sufficient number of lower ranked adjusted filter(s) may be removed from a pool of filters so as to meet a predetermined maximum size threshold. After such removal, it may be determined at operation 904 that a current size of a pool of filters is permissible for a next epoch.

FIG. 10 is a flow diagram 1000 illustrating an example method for selecting one or more mobile device position values from a pool of filters according to an implementation. As illustrated, flow diagram 1000 may include three operational blocks 1002-1006. For certain example implementations, at operation 1002, adjustment amounts that are associated with adjusted filters of a pool of filters may be compared. For example, an adjustment distance amount for a current epoch for each adjusted filter may be compared to other such adjustment distance amounts for other adjusted filters. Alternatively, an adjustment distance amount averaged over some number of epochs for each adjusted filter may be compared to other such adjustment distance amounts averaged for other adjusted filters. As another example, an adjustment amount may comprise a total number of adjustment times and/or a total adjustment distance (e.g., since its inception, over some most-recent number of epochs, etc.) for each adjusted filter that is still considered acceptable (e.g., in accordance with an acceptability criterion). However, adjustment amounts may be determined differently without departing from claimed subject matter.

At operation 1004, an adjusted filter that is associated with a greatest adjustment amount may be determined. At operation 1006, an adjusted position corresponding to the adjusted filter determined to be associated with the greatest adjustment amount may be selected. However, a mobile device position value that is to be used from a pool of filters may be determined differently without departing from claimed subject matter. By way of example but not limitation, an average or other combination of multiple adjusted positions from multiple adjusted filters (and/or at least one unadjusted filter) may be used as a position value output that results from a pool of filters for a particular epoch.

Certain example methods as described herein may provide for relatively low complexity tracking of a mobile device over a constrained map. In example implementations, additional map information may be incorporated into trajectory estimation. Map information such as routability and feasibility may influence an estimate generated by a system. By maintaining at least one unadjusted filter, such a system may avoid the aforementioned problems with forced filters. Furthermore, one or more adjusted filters may be used to estimate a trajectory by actively pruning unacceptable adjusted filters from an otherwise viable pool of smoothing filters (which may therefore remain effectively unbiased over time). If a fixed maximum number of relatively simple, e.g., smoothing filters such as EKFs are implemented, a computational complexity may be kept manageable. Moreover, such an example framework may provide for a soft trade-off between additional filtering complexity and an expected accuracy of position estimates.

FIG. 11 is a schematic diagram illustrating an example device 1100. according to an implementation, that may implement one or more aspects of using filtering with mobile device positioning in a constrained environment. As illustrated, device 1100 may include at least one processor 1102, one or more memories 1104, at least one communication interface 1106, at least one power source 1108, and other component(s) 1110, such as an SPS unit (SPSU) (not explicitly shown). Memory 1104 is illustrated as including instructions 1112. However, a device 1100 may alternatively include more, fewer, and/or different components from those that are illustrated.

For certain example implementations, device 1100 may include and/or comprise an electronic device. Device 1100 may comprise, for example, any electronic device having at least one processor and/or memory. Examples for device 1100 include, but are not limited to, relatively fixed processing devices (e.g., a desktop computer, one or more server computers, at least one telecommunications node, an intelligent router/switch, an access point, some combination thereof, etc.), relatively mobile processing devices (e.g., a notebook computer, a personal digital assistant (PDA), a netbook, a slate or tablet computer, a portable entertainment device, a mobile phone, a smart phone, a mobile station, some combination thereof, etc.), and so forth.

Power source 1108 may provide power to components and/or circuitry of device 1100. Power source 1108 may be a portable power source, such as a battery, or a fixed power source, such as an outlet in a car, house, or other building. Power source 1108 may also be a transportable power source, such as a solar or carbon-fuel-based generator. Power source 1108 may be integrated with or separate from device 1100.

Processor 1102 may comprise any one or more processing units. Memory 1104 may store, contain, or otherwise provide access to instructions 1112 (e.g., a program, an application, etc. or portion thereof; operational data structures; processor-executable instructions; code; some combination thereof; and so forth) that may be executable by processor 1102. Execution of such instructions 1112 by one or more processors 1102 may transform device 1100 into a special-purpose computing device, apparatus, platform, some combination thereof, and so forth.

Instructions 1112 may include positioning instructions 1112a, mapping information 1112b, and so forth, just to name a few examples. Mapping information 112b may correspond to, for example, mapping information 314 (of FIG. 3). Positioning instructions 1112a may correspond to, for example, instructions that are capable of realizing at least a portion of one or more implementations of flow diagrams 500, 800, 900, and/or 1000 (of FIGS. 5, 8, 9, and 10). Positioning instructions 1112a may be executed to, for example, determine a position of a mobile device based at least partly on mapping information 1112b for a constrained environment. Although not explicitly shown, instructions 1112 may also include instructions to further track a trajectory of a mobile device, to provide one or more location-based services (LBS), and so forth, just to name a few examples.

In an example implementation, a relatively fixed processing device, such as a server and/or telecommunications node, may execute positioning instructions 1112a to determine a mobile device position based at least partly on mapping information 1112b. A same or a different relatively fixed processing device may use such a determined position to provide a LBS to, e.g., a mobile device, which may include an SPSU. Alternatively, such a relatively fixed processing device may provide mapping information 1112b and/or a determined position to a mobile device to enable or otherwise further performance of some LBS. As still another alternative, a mobile device may include positioning instructions 1112a to determine its own position based at least partly on mapping information 1112b. Other alternatives may instead be implemented without departing from claimed subject matter.

Communication interface(s) 1106 may provide one or more interfaces between device 1100 and other devices (e.g., and/or human operators). Hence, communication interface 1106 may include a screen, speaker, keyboard or keys, or other human-device input/output feature(s). Communication interface 1106 may include a transceiver (e.g., transmitter and/or receiver), a radio, an antenna, a wired interface connector or other such apparatus, some combination thereof, etc. to communicate wireless and/or wired signals (e.g., over wireless or wired communication links). Communication interface 1106 may also serve as a bus or other interconnect between and/or among other components of device 1100. Other component(s) 1110, if present, may comprise one or more other miscellaneous sensors, features, and so forth.

Methodologies described herein may be implemented by various means depending upon applications according to particular features and/or examples. For example, such methodologies may be implemented in hardware, firmware, software, discrete/fixed logic circuitry, any combination thereof, and so forth. In a hardware and/or logic circuitry implementation, for example, a processor/processing unit may be implemented within one or more application specific integrated circuits (ASICs), digital signal processors (DSPs), digital signal processing devices (DSPDs), programmable logic devices (PLDs), field programmable gate arrays (FPGAs), processors generally, controllers, micro-controllers, microprocessors, electronic devices, other devices or units programmed to execute instructions and/or designed to perform the functions described herein, and/or combinations thereof, just to name a few examples. Herein, the term “control logic” may encompass logic implemented by software, hardware, firmware, discrete/fixed logic circuitry, any combination thereof, and so forth.

For a firmware and/or software implementation, the methodologies may be implemented with modules (e.g., procedures, functions, etc.) having instructions that perform the functions described herein. Any machine readable medium tangibly embodying instructions may be used in implementing the methodologies described herein. For example, software coding may be stored in a memory and executed by a processor. Memory may be implemented within the processor or external to the processor. As used herein the term “memory” refers to any type of long term, short term, volatile, nonvolatile, or other storage memory/medium and is not to be limited to any particular type of memory or number of memories, or type of media upon which memory is stored.

In one or more example implementations, the functions described may be implemented in hardware, software, firmware, discrete/fixed logic circuitry, some combination thereof, and so forth. If implemented in firmware and/or software, the functions may be stored on a physical computer-readable (e.g., via electrical digital signals) medium as one or more instructions or code (e.g., and realized as at least one article of manufacture comprising at least one storage medium having instructions stored thereon). Computer-readable media include physical computer storage media that may be encoded with a data structure, computer program, a combination thereof, and so forth. A storage medium may be any available physical'medium that can be accessed by a computer. By way of example, and not limitation, such computer-readable media can comprise RAM, ROM, EEPROM, CD-ROM or other optical disc storage, magnetic disk storage or other magnetic storage devices, or any other medium that can be used to store desired program code in the form of instructions or data structures and that can be accessed by a computer and/or processor thereof. Disk and disc, as used herein, includes compact disc (CD), laser disc, optical disc, digital versatile disc (DVD), floppy disk and blu-ray disc, where disks usually reproduce data magnetically, while discs usually reproduce data optically with lasers.

Also, computer instructions/code/data may be transmitted via signals over physical transmission media from a transmitter to a receiver (e.g., via electrical digital signals). For example, software may be transmitted from a website, server, or other remote source using a coaxial cable, fiber optic cable, twisted pair, digital subscriber line (DSL), or physical components of wireless technologies such as infrared, radio, and microwave. Combinations of the above may also be included within the scope of physical transmission media. Such computer instructions and/or data may be transmitted in portions (e.g., first and second portions) at different times (e.g., at first and second times).

Electronic devices may also operate in conjunction with Wi-Fi/WLAN or other wireless networks. For example, positioning data may be acquired via a Wi-Fi or other wireless network. In addition to Wi-Fi/WLAN signals, a wireless/mobile device may also receive signals from satellites, which may be from a Global Positioning System (GPS), Galileo, GLONASS, NAVSTAR, QZSS, a system that uses satellites from a combination of these systems, or any SPS developed in the future, each referred to generally herein as a Satellite Positioning System (SPS) or GNSS (Global Navigation Satellite System). Furthermore, implementations described herein may be used with positioning determination systems that utilize pseudolites or a combination of satellites and pseudolites. Pseudolites are usually ground-based transmitters that broadcast a Pseudo-Random Noise (PRN) code or other ranging code (e.g., similar to a GPS or CDMA cellular signal) that is modulated on an L-band (or other frequency) carrier signal, which may be synchronized with GPS time. Each such transmitter may be assigned a unique PN code so as to permit identification by a remote receiver. Pseudolites may be particularly useful in situations where SPS signals from an orbiting satellite might be unavailable, such as in tunnels, mines, buildings, urban canyons, or other enclosed areas. Another implementation of pseudolites is known as radio-beacons. The term “satellite”, as used herein, is also to include pseudolites, equivalents of pseudolites, and similar and/or analogous technologies. The term “SPS signals”, as used herein, is also to include SPS-like signals from pseudolites or equivalents of pseudolites. Certain implementations may also be applied to femtocells or a combination, of systems that includes femtocells. For example, femtocells may provide data and/or voice communication. Moreover, femtocells may provide positioning data.

In an example implementation, an SPSU (when present) may be capable of determining a location of device 1100 using an SPS system or systems. Hence, example implementations that are described herein may be used with various SPSs. An SPS typically includes a system of transmitters positioned to enable entities to determine their location on or above the Earth based, at least in part, on signals received from the transmitters. Such a transmitter typically, but not necessarily, transmits a signal marked with a repeating pseudo-random noise (PN) code of a set number of chips and may be located on ground based control stations, user equipment, and/or space vehicles. In a particular example, such transmitters may, be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., a Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (VISAS), GPS Aided Geo Augmented Navigation or GPS and Geo Augmented Navigation system (GAGAN), and/or the like. Thus, as used herein, an SPS may include any combination of one or more global and/or regional navigation satellite systems and/or augmentation systems, and SPS signals may include SPS, SPS-like, and/or other signals associated with such one or more SPS.

Some portions of this Detailed Description are presented in terms of algorithms or symbolic representations of operations on binary digital signals that may be stored within a memory of a specific apparatus or special purpose computing device or platform. In the context of this particular Specification, the term specific apparatus or the like includes a general purpose computer once it is programmed to perform particular functions pursuant to instructions from program software/instructions. Algorithmic descriptions or symbolic representations are examples of techniques used by those of ordinary skill in the signal processing or related arts to convey the substance of their work to others skilled in the art. An algorithm here, and generally, may be considered to be a self-consistent sequence of operations or similar signal processing leading to a desired result. In this context, operations or processing involve physical manipulation of physical quantities. Typically, although not necessarily, such quantities may take the form of electrical and/or magnetic signals capable of being stored, transferred, combined, compared, transmitted, received, or otherwise manipulated.

It has proven convenient at times, principally for reasons of common usage, to refer to such signals as bits, data, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “analyzing,”, “obtaining,” “filtering,” “adjusting,” “performing,” “applying,” “tracking,” “measuring,” “comparing,” “detecting,” “removing,” “ranking,” “selecting,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, and/or magnetic quantities within memories, registers, or other information storage devices, transmission devices, or display devices of the special purpose computer or similar special purpose electronic computing device.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concepts described herein. Therefore, it is intended that claimed subject matter not be limited to the particular examples disclosed, but that such claimed subject matter may also include all aspects falling within the scope of appended claims, and equivalents thereof.

What is claimed is:

1. A method comprising:
obtaining at least one position measurement of a mobile device;
filtering the at least one position measurement to produce at least one filtered position of the mobile device; and
adjusting the at least one filtered position based at least in part on mapping information to produce at least one adjusted position of the mobile device, the mapping information pertaining to a constrained environment that corresponds to at least a portion of an interior of a building structure.

2. The method of claim 1, further comprising:
adjusting an internal state of at least one filter based at least partly on the at least one adjusted position of the mobile device to produce at least one adjusted filter; and
filtering another at least one position measurement with the at least one adjusted filter to produce another filtered position of the mobile device.

3. The method of claim 2, wherein said filtering the at least one position measurement is performed by a filter of a pool of filters, said method further comprising:
determining whether one or more adjusted filters of the pool of filters fail to comport with at least one acceptability criterion; and
pruning the one or more adjusted filters from the pool of filters if the one or more adjusted filters are determined to fail to comport with the at least one acceptability criterion.

4. The method of claim 3, wherein said determining further comprises:
determining whether the one or more adjusted filters of the pool of filters fail to comport with the at least one acceptability criterion, the at least one acceptability criterion based at least partly on one or more filtered positions produced by an unadjusted filter.

5. The method of claim 3, wherein said determining further comprises:
determining whether the one or more adjusted filters of the pool of filters fail to comport with the at least one acceptability criterion, the at least one acceptability criterion being based at least partly on a moving average of one or more filtered positions produced by the one or more adjusted filters.

6. The method of claim 2, wherein said adjusting comprises:
setting the internal state of the at least one filter to comprise the at least one adjusted position of the mobile device to produce the at least one adjusted filter.

7. The method of claim 2, further comprising:
maintaining at least one original unadjusted filter in a pool of filters, the pool of filters including individual filters that are adapted to estimate a trajectory of the, mobile device.

8. The method of claim 2, further comprising:
filtering the other at least one position measurement with the at least one filter to produce a second other filtered position of the mobile device.

9. The method of claim 2, further comprising:
if a number of filters in a pool of filters exceeds a maximum threshold, ranking multiple adjusted filters of the pool of filters in accordance with at least one performance metric and removing a sufficient number of lower ranked adjusted filters to meet the maximum threshold.

10. The method of claim 2, further comprising:
from multiple adjusted positions resulting from at least multiple adjusted filters of a pool of filters, selecting at least one adjusted position corresponding to at least one adjusted filter that is selected based at least partly on amounts of adjustment associated with the at least multiple adjusted filters.

11. The method of claim 1, further comprising:
using the at least one adjusted position of the mobile device to provide a location-based service.

12. The method of claim 1, wherein the mapping information comprises routing information that identifies traversable paths for the building structure and feasibility information that identifies feasible locations of the building structure.

13. A device comprising:
at least one memory to store instructions; and
one or more processors to execute said instructions and cause the device to:
obtain at least one position measurement of a mobile device;
filter the at least one position measurement to produce at least one filtered position of the mobile device; and
adjust the at least one filtered position based at least in part on mapping information to produce at least one adjusted position of the mobile device, the mapping information pertaining to a constrained environment that corresponds to at least a portion of an interior of a building structure.

14. The device of claim 13, wherein said one or more processors are further to execute said instructions and cause the device to:
adjust an internal state of at least one filter based at least partly on the at least one adjusted position of the mobile device to produce at least one adjusted filter; and
filter another at least one position measurement with the at least one adjusted filter to produce another filtered position of the mobile device.

15. The device of claim 14, wherein a filter that is to filter the at least one position measurement comprises a filter of a pool of filters; and wherein said one or more processors are further to execute said instructions and cause the device to:
determine whether one or more adjusted filters of the pool of filters fail to comport with at least one acceptability criterion; and
prune the one or more adjusted filters from the pool of filters if the one or more adjusted filters are determined to fail to comport with the at least one acceptability criterion.

16. The device of claim 15, wherein to determine whether the one or more adjusted filters of the pool of filters fail to comport with the at least one acceptability criterion said one or more processors are further to execute said instructions to:
determine whether the one or more adjusted filters of the pool of filters fail to comport with the at least one acceptability criterion, the at least one acceptability criterion being based at least partly on one or more filtered positions produced by an unadjusted filter.

17. The device of claim 15, wherein to determine whether the one or more adjusted filters of the pool of filters fail to comport with the at least one acceptability criterion said one or more processors are further to execute said instructions to:
determine whether the one or more adjusted filters of the pool of filters fail to comport with the at least one acceptability criterion, the at least one acceptability criterion based at least partly on a moving average of one or more filtered positions produced by the one or more adjusted filters.

18. The device of claim 14, wherein to adjust the internal state of the at least one filter said one or more processors are further to execute said instructions to:
set the internal state of the at least one filter to comprise the at least one adjusted position of the mobile device to produce the at least one adjusted filter.

19. The device of claim 14, wherein said one or more processors are further to execute said instructions and cause the device to:
maintain at least one original unadjusted filter in a pool of filters, the pool of filters including individual filters that are adapted to estimate a trajectory of the mobile device.

20. The device of claim 14, wherein said one or more processors are further to execute said instructions and cause the device to:
filter the other at least one position measurement with the at least one filter to produce a second other filtered position of the mobile device.

21. The device of claim 14, wherein said one or more processors are further to execute said instructions and cause the device to:
if a number of filters in a pool of filters exceeds a maximum threshold, rank multiple adjusted filters of the pool of filters in accordance with at least one performance metric and remove a sufficient number of lower ranked adjusted filters to meet the maximum threshold.

22. The device of claim 14, wherein said one or more processors are further to execute said instructions and cause the device to:
from multiple adjusted positions resulting from at least multiple adjusted filters of a pool of filters, select at least one adjusted position corresponding to at least one adjusted filter that is selected based at least partly on amounts of adjustment associated with the at least multiple adjusted filters.

23. The device of claim 13, wherein said one or more processors are further to execute said instructions and cause the device to:
use the at least one adjusted position of the mobile device to provide a location-based service.

24. The device of claim 13, wherein the mapping information comprises routing information that identifies traversable paths for the building structure and feasibility information that identifies feasible locations of the building structure.

25. The device of claim 13, wherein the device to execute said instructions comprises the mobile device that is present in the constrained environment.

26. The device of claim 13, wherein the device to execute said instructions comprises a fixed device that is remote from the mobile device.

27. An apparatus comprising:
means for obtaining at least one position measurement of a mobile device;
means for filtering the at least one position measurement to produce at least one filtered position of the mobile device; and
means for adjusting the at least one filtered position based at least in part on mapping information to produce at least one adjusted position of the mobile device, the mapping information pertaining to a constrained environment that corresponds to at least a portion of an interior of a building structure.

28. The apparatus of claim 27, further comprising:
means for adjusting an internal state of at least one filter based at least partly on the at least one adjusted position of the mobile device to produce at least one adjusted filter; and
means for filtering another at least one position measurement with the at least one adjusted filter to produce another filtered position of the mobile device.

29. The apparatus of claim 28, wherein said means for filtering the at least one position measurement comprises at least part of a pool of filters, said apparatus further comprising:
means for determining whether one or more adjusted filters of the pool of filters fail to comport with at least one acceptability criterion; and
means for pruning the one or more adjusted filters from the pool of filters if the one or more adjusted filters are determined to fail to comport with the at least one acceptability criterion.

30. The apparatus of claim 29, wherein said means for determining comprises:
means for determining whether the one or more adjusted filters of the pool of filters fail to comport with the at least one acceptability criterion, the at least one acceptability criterion being based at least partly on one or more filtered positions produced by an unadjusted filter.

31. The apparatus of claim 29, wherein said means for determining comprises:
means for determining whether the one or more adjusted filters of the pool of filters fail to comport with the at least one acceptability criterion, the at least one acceptability criterion based at least partly on a moving average of one or more filtered positions produced by the one or more adjusted filters.

32. The apparatus of claim 28, wherein said means for adjusting comprises:
means for setting the internal state of the at least one filter to comprise the at least one adjusted position of the mobile device to produce the at least one adjusted filter.

33. The apparatus of claim 28, further comprising:
means for maintaining at least one original unadjusted filter in a pool of filters, the pool of filters including individual filters that are adapted to estimate a trajectory of the mobile device.

34. The apparatus of claim 28, further comprising:
means for filtering the other at least one position measurement with the at least one filter to produce a second other filtered position of the mobile device.

35. The apparatus of claim 28, further comprising:
if a number of filters in a pool of filters exceeds a maximum threshold, means for ranking multiple adjusted filters of the pool of filters in accordance with at least one performance metric and means for removing a sufficient number of lower ranked adjusted filters to meet the maximum threshold.

36. The apparatus of claim 28, further comprising:
from multiple adjusted positions resulting from at least multiple adjusted filters of a pool of filters, means for selecting at least one adjusted position corresponding to at least one adjusted filter that is selected based at least partly on amounts of adjustment associated with the at least multiple adjusted filters.

37. The apparatus of claim 27, further comprising:
means for using the at least one adjusted position of the mobile device to provide a location-based service.

38. The apparatus of claim 27, wherein the mapping information comprises routing information that identifies traversable paths for the building structure and feasibility information that identifies feasible locations of the building structure.

39. An article comprising: at least one storage medium having stored thereon instructions executable by one or more processors to:
obtain at least one position measurement of a mobile device;
filter the at least one position measurement to produce at least one filtered position of the mobile device; and
adjust the at least one filtered position based at least in part on mapping information to produce at least one adjusted position of the mobile device, the mapping information pertaining to a constrained environment that corresponds to at least a portion of an interior of a building structure.

40. The article of claim 39, wherein said instructions stored on said at least one storage medium are further executable by the one or more processors to:
adjust an internal state of at least one filter based at least partly on the at least one adjusted position of the mobile device to produce at least one adjusted filter; and
filter another at least one position measurement with the at least one adjusted filter to produce another filtered position of the mobile device.

41. The article of claim 40, wherein a filter that is to filter the at least one position measurement comprises a filter of a pool of filters; and wherein said instructions stored on said at least one storage medium are further executable by the one or more processors to:
determine whether one or more adjusted filters of the pool of filters fail to comport with at least one acceptability criterion; and
prune the one or more adjusted filters from the pool of filters if the one or more adjusted filters are determined to fail to comport with the at least one acceptability criterion.

42. The article of claim 41, wherein to determine whether the one or more adjusted filters of the pool of filters fail to comport with the at least one acceptability criterion said instructions stored on said at least one storage medium are further executable by the one or more processors to:
determine whether the one or more adjusted filters of the pool of filters fail to comport with the at least one acceptability criterion, the at least one acceptability criterion based at least partly on one or more filtered positions produced by an unadjusted filter.

43. The article of claim 41, wherein to determine whether the one or more adjusted filters of the pool of filters fail to comport with the at least one acceptability criterion said instructions stored on said at least one storage medium are further executable by the one or more processors to:
determine whether the one or more adjusted filters of the pool of filters fail to comport with the at least one acceptability criterion, the at least one acceptability criterion being based at least partly on a moving average of one or more filtered positions produced by the one or more adjusted filters.

44. The article of claim 40, wherein to adjust the internal state of the at least one filter said instructions stored on said at least one storage medium are further executable by the one or more processors to:
set the internal state of the at least one filter to comprise the at least one adjusted position of the mobile device to produce the at least one adjusted filter.

45. The article of claim 40, wherein said instructions stored on said at least one storage medium are further executable by the one or more processors to:
maintain at least one original unadjusted filter in a pool of filters, the pool of filters including individual filters that are adapted to estimate a trajectory of the mobile device.

46. The article of claim 40, wherein said instructions stored on said at least one storage medium are further executable by the one or more processors to:
filter the other at least one position measurement with the at least one filter to produce a second other filtered position of the mobile device.

47. The article of claim 40, wherein said instructions stored on said at least one storage medium are further executable by the one or more processors to:
if a number of filters in a pool of filters exceeds a maximum threshold, rank multiple adjusted filters of the pool of filters in accordance with at least one performance metric and remove a sufficient number of lower ranked adjusted filters to meet the maximum threshold.

48. The article of claim 40, wherein said instructions stored on said at least one storage medium are further executable by the one or more processors to:
from multiple adjusted positions resulting from at least multiple adjusted filters of a pool of filters, select at least one adjusted position corresponding to at least one adjusted filter that is selected based at least partly on amounts of adjustment associated with the at least multiple adjusted filters.

49. The article of claim 39, wherein said instructions stored on said at least one storage medium are further executable by the one or more processors to:
use the at least one adjusted position of the mobile device to provide a location-based service.

50. The article of claim 39, wherein the mapping information comprises routing information that identifies traversable paths for the building structure and feasibility information that identifies feasible locations of the building structure.
